(19) United States
(12) Patent Application Publication
(10) Pub. No.: US 2009/0185792 A1
(43) Pub. Date: Jul. 23, 2009

(54) DIGITAL VIDEO CAMCORDER WITH WIRELESS TRANSMISSION BUILT-IN

(75) Inventors: Ariel Braunstein, San Francisco, CA (US); Jonathan Kaplan, San Francisco, CA (US); John Louis Warpakowski Furlan, Belmont, CA (US)

Correspondence Address: Rutan & Tucker, LLP., 611 ANTON BLVD, SUITE 1400, COSTA MESA, CA, 92626, US

(73) Assignee: RUTAN & TUCKER, LLP, COSTA MESA, CA (US)

(21) Appl. No.: 12/016,816

(22) Filed: Jan. 18, 2008

(51) Int. Cl. H04N 5/00; H04Q 7/24

(52) U.S. Cl. 386/117; 370/338

(57) ABSTRACT

In general, a digital video player and recorder (camcorder) is described that may include a Wi-Fi module, a soft phone client application, and an antenna. An antenna connects to the Wi-Fi module to transmit and receive a compressed digital video signal wirelessly as radio frequency waves at transmitted frequencies and data rates established by the Wi-Fi standard to and from a Wi-Fi enabled router base station and then to a server of an instant messaging communication system that uses the Internet and then to another computing device capable of displaying video files. The soft phone client application resident on the digital video player and recorder has code to facilitate making phone calls over the internet by breaking audio and video data into packets, formatting the packets into compliance with the instant messaging communication system, encoding the server's IP address into the packets, and specially marking the packets that contain video data.

### FIELD OF THE INVENTION

Embodiments of the invention generally relate to the field of digital video imaging. More particularly, an aspect of an embodiment of the present invention relates to the field of digital video cameras with wireless communications built-in.

### BACKGROUND

Digital video cameras can offer many conveniences over conventional analog video cameras. However, some of the benefits they confer, such as the ability to view, store, and share videos, are often limited to those having a minimum level of expertise in using digital video cameras and personal computer systems. Realizing such benefits may also require complex procedures that not all users may be willing or able to perform.

In addition to the digital video camera itself, the use of a digital video camera often requires tapes, data connector cables, and additional software. Each of these additional items adds complexity to the process for capturing digital video, downloading digital video to a computer, and sharing digital videos with others. In some cases, a data cable must be available before digital video can be downloaded from the digital video camera. Some prior techniques connected a web cam via a cable to a computer, which then connected to a high speed router and then to the public phone lines and the Internet. The computer also had a proprietary phone application resident within the computer that could communicate audio data packets with a Skype-type server.

The web cam also had no display attached to the web cam or Wi-Fi capability making the user once again tied to the local area around the computer physically connected to the public phone lines. Thus, users who wish to capture, store, and share digital videos can benefit from a digital video camera that incorporates components required to accomplish these tasks into a single portable unit.

### SUMMARY OF THE INVENTION

In general, a digital video player and recorder (camcorder) is described that may include a Wi-Fi module, a soft phone client application, and an antenna. The antenna connects to the Wi-Fi module to transmit and receive a compressed digital video signal wirelessly as radio frequency waves at transmitted frequencies and data rates established by the Wi-Fi standard to and from a Wi-Fi enabled router base station and then to a server of an instant messaging communication system that uses the Internet, such as Skype or other Voice over IP connection, AOL instant messenger, Yahoo messenger, MS messenger, iChat, or other similar communication system as well as any or all of the listed systems, and then onto another computing device capable of displaying video files such as a desk top or lap top computer, a cell phone with a video display and resident software, another Wi-Fi enabled digital video player or other enabled digital video player devices comply with the IEEE 802.11 wireless Ethernet standards. The soft phone client application resident on the digital video player and recorder has code to facilitate making phone calls over the Internet by breaking audio and video data into packets, formatting the packets into compliance with the protocol of the instant messaging communication system, encoding the server's IP address into the packets, associating the computing device's phone number or network address with the packets, and specially marking the packets that contain video data. The packets are being captured, encoded, and then transmitted during the phone call.

### BRIEF DESCRIPTION OF THE DRAWINGS

The drawings refer to the invention in which:

FIG. 1 illustrates a block diagram according to an embodiment of a digital video camera.

FIG. 2 illustrates an embodiment of the digital video camera transmitting and receiving a compressed digital video signal in the packets wirelessly to and from a Wi-Fi enabled router base station and then to a server of an instant messaging communication system that uses the Internet and then onto another target computing device capable of playing and displaying video files.

FIG. 3 illustrates an embodiment of the digital video camera having multiple displays.

FIG. 4 illustrates an embodiment of the digital video camera having an extendable arm which uses a standard communications connector to plug into an external device.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific functions, named components, connections, protocols, compression standards, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

In general, a digital video player and recorder (camcorder) is described that may include an internal memory, a Wi-Fi module, a soft phone client application and an antenna. The internal memory stores digital video footage including video images captured by a digital video image sensor and sound data recorded by a digital audio sensor. The Wi-Fi module encodes audio only data files as well as video data files into packets to be transmitted at frequencies and data rates established by a Wi-Fi standard. The data in the transmitted packets is compressed. The antenna connects to the Wi-Fi module to transmit and receive the compressed digital video signal in the packets wirelessly as radio frequency waves at transmitted frequencies and data rates established by the Wi-Fi standard to and from a Wi-Fi enabled router base station and then to a server of an instant messaging communication system that uses the Internet, such as Skype or other Voice over IP connection, AOL instant messenger, Yahoo messenger, MS messenger, iChat, or other similar communication system as well as any or all of the listed systems, and then onto another target computing device capable of playing and displaying video files such as a desk top or lap top computer, a cell phone with a display and resident video software, another Wi-Fi enabled digital video player, or other enabled digital video player devices that comply with the Institute of Electrical and Electronics Engineers (IEEE) 802.11 wireless Ethernet standards or a similar standards. The soft phone client application resident on the digital video player and recorder has code to facilitate making phone calls over the Internet by breaking audio and video data into the packets, formatting the packets into compliance with a protocol of the instant messaging communication system, encoding the server's IP address into the packets, associating the target computing device's phone number or network address with the packets, and specially marking the packets that contain video data.

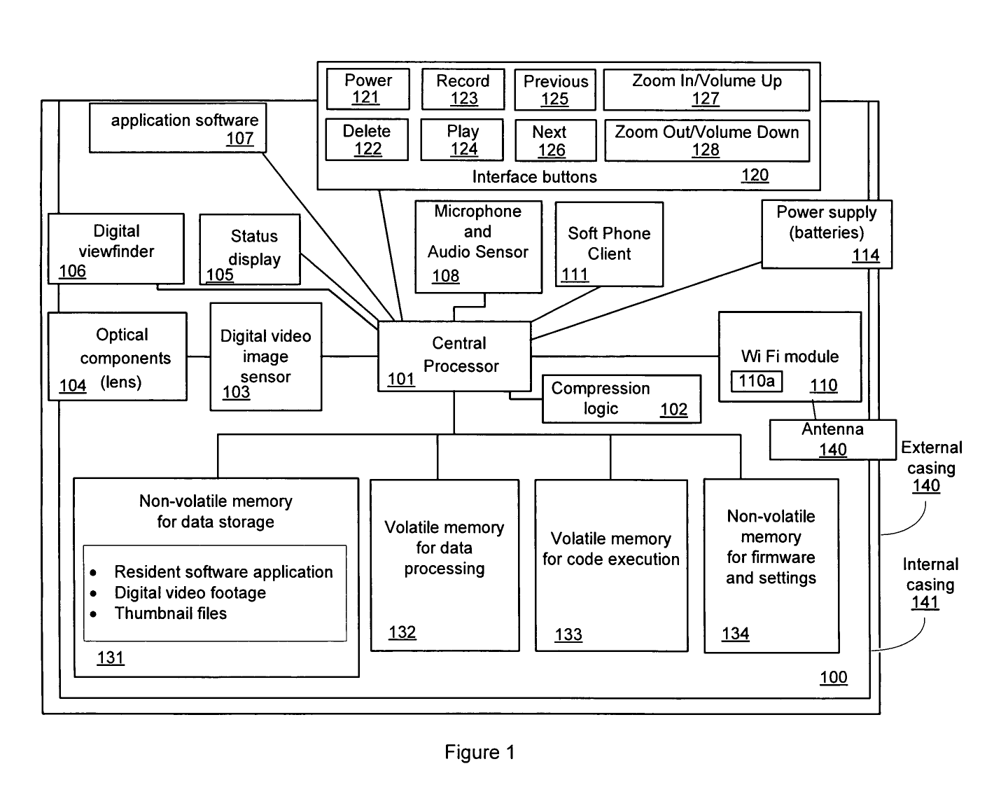

FIG. 1 illustrates an embodiment of a block diagram of a digital video camera. The digital video camera 100 may have a digital video image sensor 103, such as 1280×1024 Pixel Complementary Metal Oxide Semiconductor (CMOS) sensor or a Charge Coupled Device (CCD); an internal volatile memory 133 for code execution and temporary video content capture, such as Synchronous Dynamic Random Access Memory (SDRAM); an internal volatile memory 132 for data processing, and an internal/removable non-volatile memory for data storage 131 to store the captured digital video data. The internal/removable non-volatile memory 131 may be a combination of permanent and removable memory storage mediums that are mapped together by the systems operating system. The camera's application software 107 uses the internal/removable non-volatile memory 131 to store digital video footage captured by including video image recorded by the digital video image sensor and sound data recorded by a digital audio sensor. The camera's application software 107 may reserve portions of the internal/removable non-volatile memory 131 for recording up to an hour of a video file using the cameras onboard memory, which can then be later retrieved and sent to another person. The camera's application software 107 may also reserve a portion of the internal/removable non-volatile memory 131 to record a video or audio phone call conducted through the camera while the phone call is occurring and store the phone call data file for later recall. Thus, the camera's application software 107 has code to stream video files directly and wirelessly to a server of an instant messaging communication system on the internet via a Wi-Fi router connected to the Internet while directing that video data to also be recorded at the same time locally in the internal/removable non-volatile memory 131 within the camcorder. The camera's application software 107 presents the user with the option to save the incoming video/audio file, the outgoing transmitted audio /video file, or both for a shorter specified duration of time.

The digital video camera 100 may also have an internal non-volatile memory 134 for storage of firmware and settings; a processing unit 101, such as a micro-controller, an ASIC, or other processor; a data connector, such as a Universal Serial Bus (USB) or Institute of Electrical and Electronics Engineers (IEEE) 1394 interface; one or more a digital view finders 106 having a display; a status display screens 105, such as a liquid crystal display (LCD); a Wi-Fi module 110, a soft phone client application 111, an antenna 140, a DC power supply 114, such as batteries or a Fuel Cell; an audio indicator 116, such as a speaker; optical components 104; a microphone and audio sensor 128; a ready/recording indicator; interface buttons 120, as well as other similar components.

The digital video image sensor 103 may convert an optical image filmed by the camera into a data array. The optical components 104, which may include a lens, project the actual images onto the digital video image sensor 103 to convert the analog images into an array of digital information. The digital video image sensor 103 quantifies the variable shades of light focused on the digital video image sensor 103 by the optical components 104 into data arrays representing a discrete number of colors. In an embodiment, the digital video image sensor is at least capable of operation between night-time or dusk conditions and brighter light conditions such as 10 lux to 10,000 lux, where 1 lux is a measure of illumination equivalent to 1 lumen per square meter. The digital video image sensor may be capable of operating in lighting conditions dimmer than 10 lux and brighter than 10,000 lux. The digital video image sensor 103 may also contain an ASIC to provide several optional features such as automatic exposure adjustment, automatic white balance, and automatic gamma compensation. The automatic exposure adjustment changes the light sensitivity of digital video image sensor 103 depending upon the lighting conditions. The automatic white balance balances the hue of the color spectrum represented in the data array.

The image capturing components, including the digital video image sensor 103 and the optical components 104, may be capable of capturing large and rapid sequences of photos such as 30-60 frames per second or more over a sustained period of time. The digital video image sensor 103 may either be a CMOS sensor, CCD sensor, or other similar sensor to support this frame rate. The microphone and audio sensor 108 captures the sound corresponding to the captured images. The microphone and audio sensor 108 and the digital video image sensor 103 combine to supply the captured video content to the central processor 101. The digital video camera 100 captures a very rapid succession of still images and stores a soundtrack synchronized with the images to form a video footage file.

When the video content is captured in a digital form, the video content is easily compressible by the video compression logic block 102 to store or transfer the video content, modifiable to enhance the quality of the final video product, and transferable within the digital video camera 100 and to components external to the digital video camera 100.

The camera's application software 107 uses the internal memory component 131 to store the video stream of data and the memory components 132, 133 to develop the video stream of data. The internal memory components 132, 133 are also used during execution of code necessary to operate the digital video camera 100. Digital video camera 100 may contain multiple types of internal memory components, each type customized for a different purpose and cost. The two main types of internal memory may include volatile memory, such as synchronous dynamic random access memory (SDRAM), dynamic random access memory (DRAM), and non-volatile memory, such as flash memory and write-once memory. The non-volatile memory for data storage 131, such as a portion of a hard disk or a flash memory module, and the non-volatile memory for firmware and settings 134 are examples of non-volatile memories. Volatile memory for data processing 132 and volatile memory for code execution 133 are examples of volatile memories.

The central processor 101 may execute the firmware instructions stored in the non-volatile memory 134 and copy the instructions to the volatile memory 133 for execution. The central processor 101 executes the camera's application software 107 that operates the digital video camera 100 as well as the instructions of the soft phone client application 111. The central processor 101 also has logic to process the stream of data that is generated by the image and audio capturing components as well as transform the captured video content into a pre-defined file structure. The central processor 101 may also use portions of the volatile memory 132 to convert the raw data into captured video content in a proprietary or a standard video file format, such as Moving Picture Experts Group (MPEG) MPEG-1, MPEG-2, MPEG-4, or Motion Joint Photographic Experts Group (M-JPEG). The compression logic 102 may compress the video data prior to the storing of the captured video data in the non-volatile memory 131. The compression logic 102 may also further compress the video data as it is placed into packets prior to wireless transmission by the Wi-Fi module 110. The compression logic block 102 is used to compress the data so that it can travel more quickly via ISDN lines, broadband Internet, and Wi-Fi.

The Wi-Fi module 110 may facilitate communications between the components internal to the digital video camera 100 and devices external to the digital video camera 100. The Wi-Fi module 110 includes a resident software application and an electronic circuit, configured to encode audio only data files as well as video data files into packets into packets to be transmitted at frequencies and data rates established by a Wi-Fi standard. Communication components in the Wi-Fi module 110 may include controllers and a circuit to allow data from the non-volatile memory for data storage 131 to be transferred to one or more external devices. The data may be transferred according to a communication protocol such as IEEE 802.11, or other wireless communication protocol. The data transfer process may also include further data compression, encryption, and decryption processes. The data in the packets is compressed by the compression logic 102.

The antenna 140 connects to the Wi-Fi module 110 to transmit and receive a compressed digital video signal in the packets wirelessly as radio frequency waves at transmitted frequencies and data rates established by the Wi-Fi standard to and from a Wi-Fi enabled router base station. The Wi-Fi enabled router base station may be a Wireless Access Point (WAP) or other similar device. An antenna 140 at the Wi-Fi enabled router base station picks up the radio frequency signals. The wireless router base station has a physical communication connection to the Internet. The Wi-Fi enabled router base station receives the packets addressed to a server of an instant messaging communication system that uses the Internet, such as Skype or other Voice over IP connection, AOL instant messenger, Yahoo messenger, MS messenger, iChat, or other similar communication system as well as any or all of the listed systems and passes those packets onto the server. The packets also contain information that allows the call center server of the instant messaging communication system to route the packets then onto another target computing device capable of playing and displaying video files, such as a desk top or lap top computer, a cell phone with a video display and resident video software, another Wi-Fi enabled digital video player, or other enabled digital video player devices comply with the IEEE 802.11 wireless Ethernet standards.

The soft phone client application 111 resident on the digital video player and recorder has code to facilitate making phone calls over the Internet by breaking audio and video data into packets, formatting the packets into compliance with the protocol of the instant messaging communication system, encoding the server's IP address into the packets, associating the target computing device's phone number or network address with the packets, and specially marking the packets that contain video data.

The Wi-Fi application portion of the Wi-Fi module 110 has code for features to increase bandwidth and transfer data rates to accommodate Web-based applications and phone-based audio and video files. High data rates are used for downloading information from the Internet and sending and receiving large, multimedia files. The packets of digital video footage that are being captured, encoded, may be then transmitted during the phone call to another device capable of playing that digital footage.

Wi-Fi module 110 has other code and logic blocks configured to allow the video camera to be truly a portable and wireless mobile device. The Wi-Fi application of the Wi-Fi module 110 has code to detect and connect to any router or Wi-Fi connection within the range of the video camera's broadcast area. The resident Wi-Fi software has wireless adapters and the drivers that allow it to operate. The Wi-Fi application is coded to automatically and periodically call a home server to get software updates including new drivers and adapters as they are generated. The resident Wi-Fi software in the Wi-Fi enabled video camera has code configured to automatically detect existing Wi-Fi networks broadcasting in the area. This means that when the user turns on the Wi-Fi feature of the digital camera in a Wi-Fi hotspot, the software in the Wi-Fi enabled video camera presents this information on the display screen that the network exists and asks whether the user wants to connect to this Wi-Fi network. If yes the code then establishes a communication channel between the Wi-Fi enabled video camera and the Wi-Fi router base station.

The Wi-Fi module 110 also has electronic tuner filters specifically optimized for Wi-Fi frequencies and the multiple channels in the Wi-Fi frequencies. The software has code configured to find which Wi-Fi channel is the best connection (i.e. strongest signal rating and most bandwidth available for the video camera to use, for example, least shared bandwidth with other Wi-Fi devices attempting to use that channel.) The Wi-Fi module 110 also has a transmitter 110a that has multiple levels of power boost to extend the transmission range of the Wi-Fi signal from the antenna 140. However, the greater the level of power boost selected by the user, the sooner the DC power source will need to be recharged/replaced with another charged DC power source.

The Wi-Fi module 110 also wirelessly receives video signals encoded in the instant messaging communication system's transmission format. An Internet instant messaging system conversion application, such as a Video-to-VoIP application, changes the video signals in the instant messaging communication system's format to another format such as MPEG to be displayable on and audible from the video camera. The instant messaging communication system conversion application also performs the reverse to convert video data in a standard camcorder output format such as MPEG to the instant messaging system's format.

In an embodiment, a video conversion module separate from the Wi-Fi module 110 is implemented to convert from a standard digital video format, such as MPEG, to the instant messaging communication system's format and perform the reverse conversion. For example, the video conversion module may be part of the compression block of logic 102 and integrated into the process of compressing and decompressing the video data for transmitting.

The compression logic 102 may use video and audio compression techniques such as variants of Moving Pictures Experts Group (MPEG), Motion Joint Photographic Experts Group (M-JPEG), Pulse Code Modulation (PCM) or similar compression standards. The compression logic 102 may compress video and audio data by compression of composed video images, compression of three video channels (R, G, B), compression of raw sensor data in separate video channels (R, G1, B, G2), down sampling the frame-rate of a video stream, or by conducting other similar compression techniques.

The digital viewfinder 106 has a display to allow a user to see the images in a target area to be to be captured in the digital video footage and then recorded in the non-volatile digital storage medium. A user can use the digital viewfinder 106 to view the scene while the capture is taking place. The display of the digital viewfinder 106 also allows the user to review video data that has been recorded in the non-volatile memory for data storage 131. Thus, the digital viewfinder 106 may be used for both targeting the subject of the video capture as well as reviewing the captured data. The digital viewfinder 106 may be used for two-way viewing between caller and callee showing both what video images are being transmitted from the Wi-Fi module 110 and what video images the Wi-Fi module 110 is receiving. The digital viewfinder 106 may be an active electronic component such as an active matrix or reflective liquid crystal display (LCD). The playback display portion of the digital viewfinder 106 may be a higher quality multi-shade display capable of showing dual-tone or full color pictures and/or video segments. The digital video camera 100 may also have an optical viewfinder (not shown) implemented using a set of lenses and optical elements. As will be discussed in more detail later, the digital view finder may have one or more displays as part of the digital video camera and may be fully contained in the camera body or allow the digital viewfinder's display to merely attach to the camera body and rotate.

The status display 105 visually communicates information, such as displaying current camera status, remaining recording time, battery level, low lighting conditions, and other similar information. The status display 105 may include an LCD, which may be an ultra low-energy consumption black and white segment-based display that shows pre-defined symbols and patterns.

Ready/recording indicator may also visually communicate information, such as ready state and recording mode information to a user. The ready/recording indicator, for instance, may include a light emitting diode (LED) which can be lit, blinking, or off, depending on whether the camera is either ready to begin recording or currently recording.

The digital video camera 100 may have a camera body made from an internal casing 141 and an external casing 140. The casings 141 and 140 protect the digital video camera during handling and use. The internal casing 141 may contain the electronic components associated with the digital video camera 100. The external casing 140 may be a hard shell designed to protect the digital video camera 100. A layer of protective material, such as Styrofoam, may exist between parts of the internal casing 141 and external casing 140.

The power supply 114 supplies power for all of the components within the digital video camera 100, however, once the video content is captured and stored in the non-volatile memory for data storage 131, then the power supply 114 is no longer required to maintain the captured video data. The power supply 114 may contain several circuits with different power requirements. The power supply 114 may include any type of battery, fuel cell, single-use or rechargeable direct current (DC) power source, may connect up to an external alternating current (AC) source, or some other source such as a USB connection.

The interface buttons 120 may include physical buttons such as a power button 121 for enabling power supply 114; a delete button 122 for deleting data from the non-volatile memory for data storage 131; a record button 123 for beginning capture of digital video footage when the digital video camera 100 is in a ready state, and ending capture of digital video footage when the digital video camera 100 is in a recording state; and a play button 124 for playing digital video footage from non-volatile memory 131. The interface buttons 120 may also include a previous button 125, a next button 126, a zoom in/volume up button 127, and a zoom out/volume down button 128. The previous 125, next 126, zoom in/volume up 127, and zoom out/volume down 128 buttons may be located on a four-position rocker switch. The previous button 125 and the next button 126 can be used to select one of several digital video files stored on the non-volatile memory 131 for playback or deletion. The zoom in/volume up button 127 and the zoom out/volume down button 128 may operate as soft-key buttons, which can have different functions depending on a mode in which the digital camera 100 is operating. For example, while the digital video camera 100 is playing back content, the zoom in/volume up button 127 can be used to increase the audio volume. Otherwise, the zoom in/volume up button 127 can be used to increase the apparent focal length, or zoom, of an image being captured or viewed on the digital viewfinder 106. Likewise, the zoom out/volume down button 128 can operate to either decrease the audio volume during playback or decrease the apparent focal length of an image being captured or viewed.

The non-volatile memory for data storage 131 may be used in the digital video camera 100 to store any type of data. For example, the non-volatile memory 131 may be used to store digital video footage captured using the digital video image sensor 103, thumbnail files associated with digital video files, or a resident software application. The non-volatile memory 131 can also store still photo files, audio files, or any other type of data. In an embodiment, the non-volatile memory 131 may include non-volatile memory such as a 512 megabyte NAND flash memory module or another type of flash memory module, so that the contents of the non-volatile memory 131 are preserved even when no power is being supplied to the non-volatile memory 131. The non-volatile memory 131 may also utilize storage technologies besides flash memory technology. For instance, the non-volatile memory 131 could also be implemented by a hard disk drive or optical media such as a writable CD or DVD. In an embodiment, the non-volatile memory 131 may be removable from the digital video camera 100. A user can then change the capacity or the content of memory available to the digital video camera 100. In other embodiments, the non-volatile memory 131 may not be removable from the digital camera 100. In a digital video camera 100 having a non-removable non-volatile memory 131, the use of the digital video camera 100 is simplified because non-volatile memory 131 will always be available for storage of digital video footage or other data.

The non-volatile memory for firmware 134 may store firmware instructions for functional features that provide the consumer with a better usage experience. The firmware allows a user to perform various actions related to the capture, playback, and deletion of digital video footage. For instance, the firmware begins the capture of digital video footage upon detecting a press of the record button 123 while the camera is in a ready state and ends the capture of digital video footage when the record button 123 is pressed while the digital camera 100 is recording. The firmware may also allow a user to select from digital video files stored in the non-volatile memory for data storage 131 using the previous button 125 and the next button 126. The firmware may further allow the user to play back a selected digital video clip by pressing the play button 124, or to delete a selected digital video clip from the non-volatile memory 131 by pressing the delete button 122. Upon deletion of a digital video clip from the non-volatile memory 131, the firmware may recalculate and display the remaining time available for recording, based on the available space in the non-volatile memory 131. The firmware thus maximizes the utility of the available non-volatile memory 131 capacity, since a user can delete unwanted digital video footage or other data to make room for additional digital video footage or other data. The firmware may also provide other features such as a timer function. In an embodiment, the timer function implemented by the firmware can cause the digital video camera 100 to wait for a predetermined time before automatically capturing a digital video clip having a pre-defined duration. For example, the digital video camera 100 may automatically record fifteen seconds of video after ten second delay following activation of the timer function.

The firmware may also automatically generate a thumbnail image associated with each digital video file stored in the non-volatile memory for data storage 131. The thumbnail file may also be stored in the non-volatile memory 131 and may be used by the firmware to represent digital video files in the digital viewfinder interface, on a television screen, or on a display associated with an external device. The thumbnail files can be used in this way to suggest the content of digital video files to a user. Thumbnail files may also be similarly generated and used by a resident software application stored in the non-volatile memory for data storage 131.

The digital video camera 100 may also capture high quality still images instead of a digital video clip. For example, a single high-resolution still photo shot may occupy as much memory as 15 seconds of digital video footage in the non-volatile memory for data storage 131. The digital camera 100 may also record an audio segment associated with a still photo shot or series of photo shots, and store the audio segment in the non-volatile memory 131 as two separate files instead of one video file.

Lower cost versions of the digital camera may contain more limited amount and type of internal memory. These cameras have the camera's application software 107 and the Wi-Fi module 110 configured, when turned on, to continuously feed recorded video files in the internal memory 131 wirelessly to any detected and communications connected Wi-Fi router base station within the broadcast range. The video files are then routed to a server on the Internet for more permanent storage. After all of a video file or a portion a video file broken up into discreet segments is confirmed successfully transferred to the server on the Internet, then the camera's application software 107 has code to erase all or that segment of the video file from the video camera's internal memory 131.

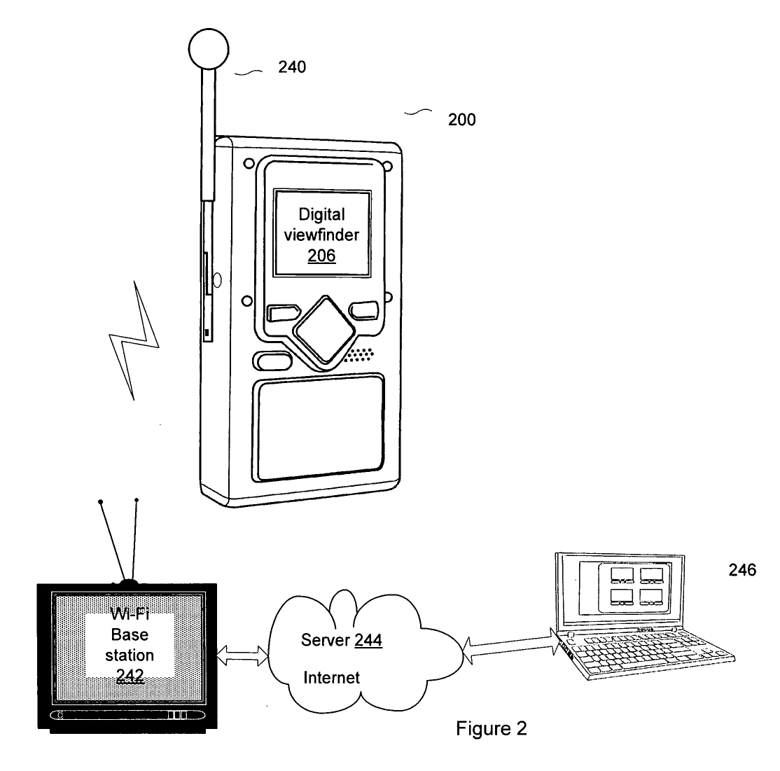

FIG. 2 illustrates an embodiment of the digital video camera transmitting and receiving a compressed digital video signal in the packets wirelessly to and from a Wi-Fi enabled router base station and then to a server of an instant messaging communication system that uses the Internet and then onto another target computing device capable of playing and displaying video files. An embodiment of a digital video camera 200 transmits video files wirelessly to and from a Wi-Fi enabled router base station 242 and then to a server 244 of an instant messaging communication system that uses the Internet and then onto another target computing device 246.

Overall, the video camera 200 may cooperate with Voice over Internet Protocol (VoIP) Internet phone service systems. The video camera 200 makes a VoIP call, and the user uses the video camera 's built-in microphone and speakers, an external headset communicating with the camera, an IP phone, or a phone plugged into an analog telephone adapter in place of an ordinary phone during the phone call. Note, a numeric keypad can also be plugged into the camera to dial the numbers of the phone call or user may scroll through the contact list presented by the software on the display 206, or scroll up and down a numeric keypad presented on the display to enter numbers presented on the display. The video camera 200 translates the analog signals of a user's voice and/or video files into a digital signal. The Wi-Fi enabled video camera 200 streams video files stored in a first portion of the internal memory as packets directly and wirelessly to a server 244 on the Internet via the Wi-Fi router base station 242 while the internal memory has another portion allocated to being able to record that video data locally within the Wi-Fi enabled video camera 200 at the same time. The digital signal travels over the Internet. Once the data reaches the target computing device 246 destination, the telephone or computer that answers the call translates the data representing the user's voice and/or video files back into analog sound and as a displayable video file.

Initially, video input from the digital video image sensor and audio input from the microphone are converted to digital data. The video camera's application software “grabs a frame” from the digital camera 200 at a preset interval (for example, the software might grab a still image from the camera 30-60 times a second) and then transfers the frame for processing and then storage in the internal memory. Once the video camera software captures a frame, the instant messaging system conversion application converts the format and compresses the video data.

The compression block is used to compress the data so that it can travel more quickly via ISDN lines, broadband Internet or Wi-Fi. A lot of compression-decompression calculations and operations can be pushed onto the server 246. In an embodiment, the compression logic generates and then the Wi-Fi module transmits a number of symbols representing compression-decompression operations to be performed on the transmitted packets of video data by the server 246 of the instant messaging communication system.

The Wi-Fi module detects and establishes a wireless communication link between the video camera 200 and the router base station 242. The Wi-Fi module broadcasts the video data over the antenna 240 to the detected Wi-Fi base station 242. In an embodiment, there are several broadcast methods. The software can turn the images and corresponding audio into a compressed MPEG file and upload the compressed MPEG file to the Web server 244 using File Transfer Protocol (FTP) or may use User Datagram Protocol (UDP) protocol to transfer the video cam images from the camcorder to another computer. When UDP is used packet sequence checking and error notification is written into the Internet instant communication system conversion application.

The soft phone application marks the packets that contain video data to increase the quality for any VoIP service as well as quality of a person's Internet connection. The data packets containing the call and video are marked and given a priority so that the data packets are not lost or slowed down in transit, a lesser chance exists that the call can become distorted or pieces of the conversation can disappear entirely.

In addition to standard VoIP communication protocol that merely uses packet switching for plain audio calls, the soft phone client application may also use module switching for video marked packets. Module switching leaves an entire communication channel open during the whole video conversation. Standard VoIP communication protocol breaks the conversation into small packets of data, which can be interspersed with data packets from other devices on the same channel. Standard VoIP communication protocol then transmits that audio-only data over the Internet. The video camera sends and receives data as needed for audio-only conversations from and thus can be easily interspersed with other device's data packets. However, with the continuous feed video data, the VoIP communication channel open is left open as data packets are continuously being sent.

When the user makes a call on the Wi-Fi enabled video camera 200, the user dials the number of the person/target computing device 246 the user wants to call. Note, if the user is calling another VoIP user, the user may enter a VoIP address instead of a phone number, depending on the service provider's requirements. The soft phone application also translates the numbers a user dials/dial tones into packets of data. The soft phone application may use an analog telephone adapter. The ATA receives the signal and sends a dial tone to let you know that you have a connection to the Internet. The Wi-Fi module uses the antenna 240 and radio waves to transmit the packets to the wireless receiver in the Wi-Fi router base station 242. The wireless router base station 242 decodes the data packets enough to route the packets to their next destination. The wireless router base station 242 sends the information to the Internet using a physical, wired Ethernet connection. The receiver passes the information over the Internet to the call processor like an ordinary VoIP call. The call processor maps the phone number by translating it to an IP address. A specialized mapping program called a soft switch connects the video camera's ATA to the target computing device's ATA. The call processor sends a signal to the target computing device's ATA, telling the computing device to ring. The call processor may wait for the target computing device's user to pick up and answer the phone call to establish a session between the two devices. Each system now knows to expect packets from the other.

When the user begins the conversation, the video camera 200 transmits the audio-only or video data in packets as well. The packets travel over the Internet just like it does in a VoIP call, although the specifics can differ from one provider to another. The normal Internet infrastructure treats the audio-only un-marked packets just like it would for an e-mail message or a Web page but treats the video marked packets as a continuous feed packet. Unlike a cell phone which can merely call land lines or cell phones, the video camera can call up a computer by its associated network address, an analog landline by its phone number, a cell phone by its phone number, another Wi-Fi phone device by its phone number, and transmit the compressed video data packets to these devices as well as receive video files from these devices.

In an embodiment, the video camera uses a specific Wi-Fi service or network such as Skype service and Vonage service. The Wi-Fi video camera 200 has software with code to set up an account with such a provider.

The Wi-Fi network's hotspot can separate and prioritize the video traffic based on the markings to treating the marked packets as a separate signal and provide better voice and video quality.

When the data reaches its destination target computing device 246, the voice and video data is decompressed to be viewed on a computer monitor or other display screen and heard through the target computing device's speakers. Acoustic echo cancellation software can be used to remove sound interference and eliminate delays so that sound and visuals are in synch.

In an embodiment, a proprietary instant messaging system, such as Skype, cannot be used with standard VOIP analogue telephone adapters (ATAs), which use Session Initiation Protocol (SIP), H323, and other protocols. Consequently, Skype users are limited to either using software phones that have Skype formatted ATAs. However, the video camera may have an application that enable users to make free calls from Skype to SIP protocol VoIP providers, or vice versa. The application makes the protocols conversions between the proprietary IP ATA and the standard SIP ATA.

The digital video camera may also have interface buttons including a power button, a delete button, a record button, and a play button. The interface buttons may also include a previous button, a next button, a zoom in/volume up button, and a zoom out/volume down button, which may be located on a four-position rocker switch. The digital video camera may also be connected to a television through television connector, such that digital video or other images can be displayed on the television.

An embodiment of a digital video camera includes an external casing that is designed to enclose the internal components of the digital video camera. External casing may also be designed to address such considerations as ease of use and durability. For instance, external casing may be sized so that the digital video camera can fit easily into a user's pocket. External casing may also be manufactured from a hard plastic, metal, or other durable material to improve durability of the digital video camera. In an embodiment where external casing is manufactured from a durable material, external casing can protect the internal components of the digital video camera from physical shock, moisture, and other harmful elements.

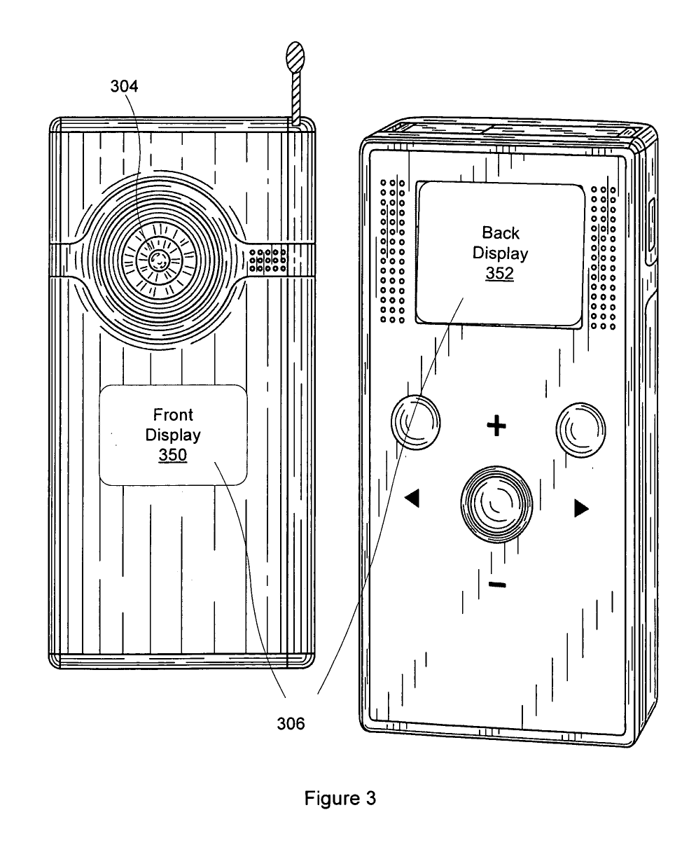

FIG. 3 illustrates an embodiment of the digital video camera with multiple displays. The video camera's application software and hardware provide video conferencing for people at two or more locations to see and hear each other at the same time through the camera's internal communications technology. The people exchange visual information on the display of their computing device, such as the front display 350 and back display 352.

The digital viewfinder 306 may be used for two-way viewing between caller and callee showing both what video images are being transmitted from the Wi-Fi module and what video images are being received from the Wi-Fi module. When using the video call option presented by the video camera's application software, the user can choose to see (on the camcorder display) one of the following: what he/she is broadcasting on either the front display screen 350 or back display screen 352; the video broadcasted from the target computing device on the front display screen 350; a Picture in Picture on one of the display screens 350, 352 with the incoming video file from the target computer in a small corner picture of the display with the remainder of the display filled up with what he/she is broadcasting; a Picture in Picture on the one of the display screens 350, 352 with the outgoing video file from what is in-front of the user in a small corner picture of the display with the remainder of the display filled up with what he/she is receiving; or a split screen where half the display 350, 352 shows video of what is being transmitting and the other half of the screen shows what video is being received; or similar displays presentations of both what video is broadcasting and what video is receiving.

Alternatively, a single display 352 for displaying video may be part of the camera and be detachable from the body so the display may be rotated toward the user. Also, the lens 304 for capturing video can rotate creating two modes as follows. The display screen 352 and lens 304 are on the same side of camera for standard person-to-person calls. The display 352 and lens 304 are on opposite sides to broadcast what's is in-front of the user—like a camcorder.

The lens 304 may be mounted in a semi-rigid flexible cable and attached to an optical fiber within the semi-rigid flexible cable similar to flexible pipe tubing. The semi-rigid flexible cable can be bent and pointed in any direction the user desires the video to point at and due to the semi-rigid nature always maintain a minimum bend radius for the optical fiber. Similarly, the detachable display screen 352 may be attached with rotatable clips and optical fiber to the camera body.

The video camera may also have two separate lenses for capturing video connect to the camera body: where a first lens 304 connects physically in the front of the camera and another lens mounts in the back for focusing on the user viewing the display 352.

Each lens could feed its own high-resolution image sensors or a common image sensor. The processor chip and resident software may also support complex functions such as real-time web browsing, sharing multimedia files or playing music without placing too great a demand on the phone's battery.

The resident soft phone application wizard has code to show a user how to add contacts, make calls and import contact information from your address book. The resident soft phone application wizard shows a user how to sign up for an account at the instant messaging system's Web page, to follow a link from the program to create a user's username and password.

The resident soft phone application wizard has code to allow a user to change their online status, look at the user's contact list, review stored video files, and make phone calls. In order to use these functions and to make calls.

In an embodiment, the Internet instant communication system account information and login information, such as a Skype ID, can be set on computer running the client application that comes with the video camera. The list of contacts and there phone number and or network address can be read from the user's account on the server via code in the client application.

The soft phone client application can make calls with or without video files i.e. (can act as a voice-only phone). The camera's application software can run the video camera as a normal camcorder with the Wi-Fi functionality turned off so the camera records the video locally and consumes less power. The external casing has a fixture to mount the camera on a desk top computer and the camera's application software communicates to the computer and identifies itself as a web cam. The external casing may also have a tripod mount.

One or more connection ports exist in the external casing and circuitry in the camera to connect to standard (wired) headsets, and to connect to Bluetooth wireless headsets. Also, while on a call, the camcorder speaker can be used as a speakerphone. The camera's application software allows the phone calls to be recorded locally in the internal memory both voice and video for review later. Thus, the incoming and transmitted video files or audio only files can be recorded to non-volatile memory while the phone call is still occurring. The camera's application software allows the phone calls or even whatever images are being shown on the LCD display of the view finder to be projected on a TV set—allowing for a large-screen conference call or group review of stored video footage. Thus, the video camera has a TV out module and jacks in the camera body to convert the video signals into a TV format and whatever video file or video files are being presented on the display will also be projected onto a connected TV set. The camera's application software has code to allow received text messages from another communication device to be overlaid and displayed on the display even during a phone call in which the Wi-Fi module is receiving video data files being displayed on the display. The power supply can connect to external power (to allow for long calls). The camera's application software 107 allows 2-3× digital zoom. The video files may have an example a video image resolution of 640×480 at up to a data rate of up to 60 frames per second.

In an embodiment, the Wi-Fi module that encodes audio and video data files is a wireless module that transmits according to a wireless standard such as (Bluetooth, Wi-Fi such as 802.11_, Etc.) and can transmit packets in a VoIP format. The Wi-Fi module 110 can transmit on any of three frequency bands in the 802.11 wireless standard. Or, the Wi-Fi module can “frequency hop” rapidly between the different bands. Frequency hopping helps reduce interference and lets multiple devices use the same wireless connection simultaneously.

Note, other wireless standards may also be employed by the Wi-Fi module such as 802.15, used for Wireless Personal Area Networks (WPANs) including Bluetooth technology, and WiMax, also known as 802.16 that combines broadband and wireless.

In an embodiment, the Wi-Fi module of the Wi-Fi enabled video camera uses different frequencies than cellular phones do. Cell phones use 824-MHz to 894-MHz frequency bands. The Wi-Fi enabled video camera uses a Wi-Fi standard, such as the 802.11b or 802.11g standards that transmit at 2.4 GHz as well as the 802.11a standard that transmits at 5 GHz. These frequencies are considerably higher than the frequencies used for cell phones, walkie-talkies and televisions. The higher frequency allows the signal to carry more data.

The Wi-Fi module may use the following 802.11 networking standards or similar standards, which come in several flavors:

802.11a transmits at 5 GHz and can move up to 54 megabits of data per second. It also uses orthogonal frequency-division multiplexing (OFDM), a more efficient coding technique that splits that radio signal into several sub-signals before they reach a receiver. This greatly reduces interference.

802.11b is the slowest and least expensive standard. For a while, its cost made it popular, but now it's becoming less common as faster standards become less expensive. 802.11b transmits in the 2.4 GHz frequency band of the radio spectrum. It can handle up to 11 megabits of data per second, and it uses complimentary code keying (CCK) coding.

802.11g transmits at 2.4 GHz like 802.11b, but it's a lot faster—it can handle up to 54 megabits of data per second. 802.11g is faster because it uses the same OFDM coding as 802.11a.

802.11n is the newest standard that is widely available. This standard significantly improves speed and range. For instance, although 802.11g theoretically moves 54 megabits of data per second, it only achieves real-world speeds of about 24 megabits of data per second because of network congestion. 802.11 n, however, reportedly can achieve speeds as high as 140 megabits per second.

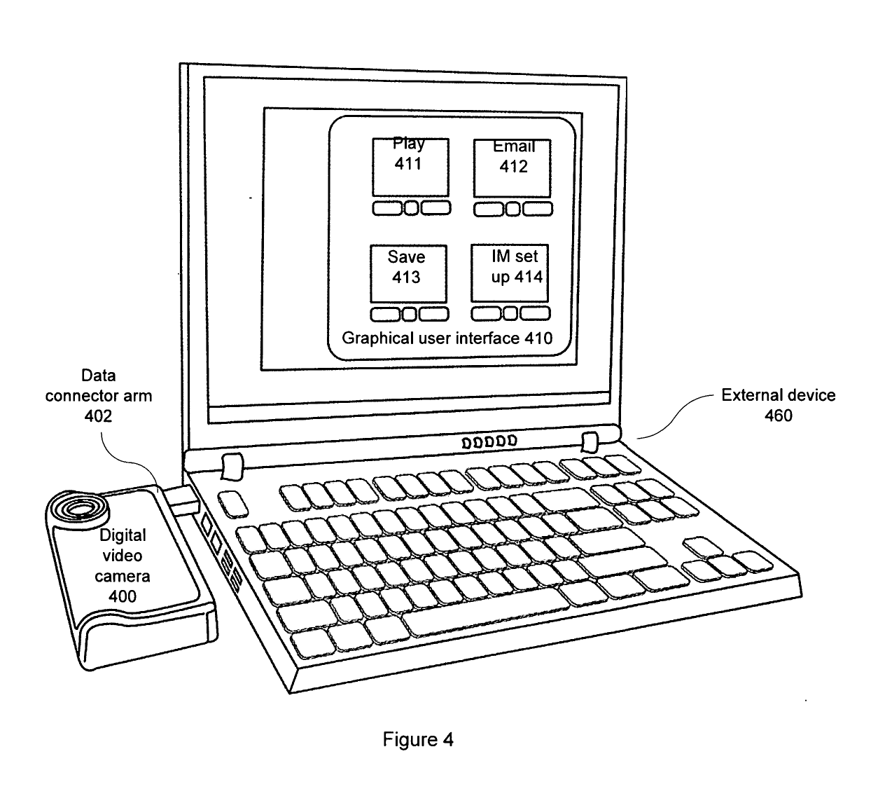

FIG. 4 illustrates an embodiment of the digital video camera having an extendable arm which uses a standard communications connector to plug into an external device.

In an embodiment, the digital video camera may have arm 402 permanently attached to the camera body. Arm 402 may have a data connector. The arm 402 and data connector assembly can retract into the camera body, or extend from the camera body. When extended, the dimensions of the arm 402 and data connector assembly provide sufficient clearance so that the data connector can be inserted directly into an appropriate receptacle on an external device such as a computer system or a processing station. After the data connector has thus connected the digital video camera to the external device, data can be transferred through the data connector from the internal memory of the digital video camera to the external device.

In an embodiment of a digital video camera, an audio indicator may be located on or near the surface of the external casing. The audio indicator may include a speaker or piezoelectric device. The position of the audio indicator in an embodiment can be selected so that sound from the audio indicator is directed towards the optimal position for a user to view the digital viewfinder. Thus, a user in the best position to view video content on the digital viewfinder 400 would also be in the best position to hear the corresponding sound from the audio indicator. The audio indicator, in an embodiment, may play sound from audio data associated with digital video footage. Audio indicator may also play sound from other types of audio data, such as audio data associated with a still photo shot, or audio data that is not associated with any still images or video content.

An embodiment of a digital video camera includes a set of interface buttons. These may include buttons such as a power button for enabling power supply, a delete button for deleting data from the digital video camera's non-volatile memory, a record button for beginning and ending capture of digital video footage, and a play button for playing digital video footage, playing audio, or viewing images from the digital video camera's non-volatile memory. The interface buttons may also include a previous button, a next button, a zoom in/volume up button, and a zoom out/volume down button. The previous, next, zoom in/volume up, and zoom out/volume down buttons may be located on a four-position rocker switch. In an embodiment, the interface buttons are positioned and sized to facilitate one-handed operation of the digital video camera. For example, the interface buttons may be centrally located and sufficiently large so that all of the buttons are accessible to a user's hand that is holding the digital video camera. In an embodiment, the interface buttons are arranged so that the digital video camera can be held and used in a vertical orientation.

An embodiment of a digital video camera provides that a television connector can be plugged into the digital video camera. Television connector then allows the transmission of a signal from the digital video camera to a television which may be connected to the other end of the television connector. The digital video camera 400 may transmit analog or digital signals through television connector to facilitate the display of data from the digital video camera's internal memory on the screen of the television. The digital video camera may also transmit signals corresponding to images from the digital video sensor. In an embodiment, television may assume some or all of the functions of the digital viewfinder. The digital video camera 400 may further display a user interface on the screen of the television. A user may then be able to interact with the user interface displayed on the screen of television by manipulating the interface buttons of the digital video camera 400. In an embodiment of a digital video camera 400 that provides for a connection to a television through a television connector, a user may be able to view digital video footage stored on the digital video camera's non-volatile memory for data storage on the screen of television. The user may also be able to use the television to frame a scene to be captured as digital video footage, or to view an ongoing capture of digital video footage on the television.

In an embodiment, a resident software application is stored in the non-volatile memory for data storage of the digital video camera 400. When a connection between the digital video camera 400 and the external device 460 is detected, an operating system running on external device 460 may automatically execute the resident software application. For example, a Windows® operating system may be configured to check the contents of the non-volatile memory of the digital video camera 400 for an “autoplay.inf” file upon detecting a connection between the digital video camera 400 and the external device 460. The “autoplay.inf” file then directs the operating system to the resident software application, which is stored in the non-volatile memory of digital video camera 400. The operating system of the external device 460 then executes the resident software application.

Upon execution, the resident software application may check the external device 460 to determine if required software components are available, then install the software components in the external device 460 if the software components are not available on the external device 460. For example, the resident software application may determine if certain compression-decompression algorithms (codecs) are available on the external device 460. If the resident software application determines that the codecs are not available on the external device 460, the resident software application may then automatically install the codecs on the external device 460 without additional user intervention. In other embodiments, the resident software application may wait for verification from a user before installing the software components. The resident software application may also install other software components such as software libraries or application files. The resident software, in an embodiment, may also cause data to be written to memory in the external device 460 for tracking purposes. For instance, the resident software may add entries or keys to the registry of a computer running the Windows® operating system so that upon a subsequent connection to the same computer, the resident software application can simply check the registry entries or keys to determine which codecs or software components were previously installed.

In an embodiment, the resident software application may produce a graphical user interface (GUI) 410 on a display associated with the external device 460. The GUI 410 may present a user with graphical controls to help the user to perform various tasks. Such tasks may include saving digital video files from the non-volatile memory of the digital video camera 400 to memory accessible to the external device 460, playing digital video footage, deleting data from the non-volatile memory of the digital video camera 400, and attaching a digital video clip to an email message, setting up an account and contact list with the instant messaging communication system 414, and other similar wizards. For purposes of illustration, FIG. 3 depicts a play control 411, an email control 412, a save and a delete control 413, and an instant messaging communication system wizard 414, which help a user to perform these tasks.

The resident software application may perform a save function in response to a user selecting the save control 413. In an embodiment, the resident software application saves data, which may be digital video footage, from the non-volatile memory of the digital video camera 400 to memory accessible to the external device 460. The resident software application may also copy files from a host computer into the internal memory of the camcorder (with internal memory or plug in memory cards). Thus, the GUI 410 allows the user to copy files onto the camcorder, through the arm, either for viewing on the camcorder, for taking them for processing on the server, or similar function. The GUI 410 allows the user to copy files of any other file type (pictures, music, etc.) into the internal memory of the camcorder.

The resident software application may perform a delete function in response to a user selecting the delete control 413 by removing data from the non-volatile memory of the digital video camera 400. The resident software application may also have the capability to delete data from the memory of the external device 460.

The resident software application may play digital video footage in response to a user's selection of the play control 411. The resident software may play the software by executing its own code to decompress, decode, and display the digital video footage, or the resident software may direct a separate application to display the digital video footage. The digital video footage played by the resident software application may be stored in the non-volatile memory of the digital video camera or any other memory accessible to the external device 460.

The resident software application may, in response to a user's selection of the email control 412, prepare an email message having an attached digital video clip. For instance, a user may wish to share a digital video clip with a contact by sending the digital video clip to the contact through email. The resident software application may compress the digital video clip so that the file size of the digital video clip does not exceed a predetermined limit. For instance, the resident software application may apply an appropriate level of compression to a digital video clip to reduce the file size of the video clip so that it does not exceed 10 megabytes. The reduced file size allows the digital video clip to be attached to an email and more easily transmitted over a computer network having limited bandwidth. The predetermined limit for the file size may be set by a camera provider, such as a manufacturer, distributor, or retailer of the digital video camera, or the user may specify the predetermined limit. The resident software application may also compress a digital video clip to meet other criteria, such as a desired bit rate or image quality. As with the predetermined file size limit, the compression levels associated with these criteria may be set by a camera provider or by the user. The resident software application may compress a digital video clip according to a Moving Picture Experts Group (MPEG) MPEG-1, MPEG-2, MPEG-4, Motion Joint Photographic Experts Group (M-JPEG) standard or another standard for encoding digital video files.

The resident software application may then invoke an email client to create a new email message to which the compressed digital video file is attached. The email client may be a separate application installed on the external device, or may also be part of the resident software application. In an embodiment, the resident software application may detect a pre-existing installation of an email client on the external device 460. After the pre-existing installation of the email client has been detected, the resident software application locates and executes an executable file of the installed email client. In an embodiment, the resident software application then uses the Messaging Application Programming Interface (MAPI) to interface with the email client. In an embodiment, the resident software application may thus create an email message and attach a digital video file to the email message without additional prompting by the user. After the resident software application invokes the email client to create a new email message to which the digital video clip is attached, the user may be given an opportunity to address the email message or complete other fields in the email message such as the subject line and message body. The user can then send the email.

In an embodiment, the resident software application may upload the digital video clip to a remote server in response to a user's selection of the email control 412. The resident software application can then invoke the email client to create a new message and embeds in the new message a link to the location of the digital video clip on the remote server. Thus, a user can simply send a link to the digital video clip instead of having to send the digital video clip.

The embodiments described above are merely illustrative of the principles of the invention. It will be apparent to one who is skilled in the art that many other variations and modifications can be made to the above-described embodiments without departing from the spirit and scope of the invention. The scope of the invention is therefore to be interpreted in accord with the limits set forth by the appended claims.

What is claimed is:

1. A digital video player and recorder (camcorder), comprising:
a lens to supply images to a digital video image sensor;
a digital audio sensor;
camera's application software to use an internal memory to store digital video footage including video images captured by the digital video image sensor and sound data recorded by the digital audio sensor;
a microphone to capture audio frequencies corresponding to captured images and supplies the sound to the digital audio sensor, where both the recorded images and recorded sound are combined into captured video footage;
a Wi-Fi module to encode audio only data files as well as video data files into packets to be transmitted at frequencies and data rates established by a Wi-Fi standard, where the data in the transmitted packets is compressed;
an antenna connected to the Wi-Fi module to transmit and receive the packets wirelessly as radio frequency waves at transmitted frequencies and data rates established by the Wi-Fi standard to and from a Wi-Fi enabled router base station and then to a server of an instant messaging communication system that uses the Internet and then onto another target computing device capable of playing and displaying video files;
a soft phone client application resident on the digital video player and recorder that has code to facilitate making phone calls over the Internet by breaking audio only and video data into the packets, formatting the packets into compliance with a protocol of the instant messaging communication system, encoding the server's IP address into the packets, associating the target computing device's phone number or network address with the packets, and specially marking the packets that contain video data;
a processing unit to execute the camera's application software that operates the digital video camera as well as the instructions of the soft phone client application;
a digital viewfinder having a display to allow a user to see the images in a target area to be captured in the digital video footage and then recorded in the internal memory;
a video compression component to compress a size of the captured video footage;
a Direct Current power source to power the digital viewfinder, the processing unit, the internal memory, the Wi-Fi module, the digital video image sensor, and the digital audio sensor; and
a camera body to house the digital video image sensor; the processing unit, the internal memory, the Wi-Fi module; and the digital audio sensor.

2. The digital camcorder of claim 1, wherein two or more displays are part of the digital video camera and a first display attaches a front side of the camera body and a second display attaches a back side of the camera body.

3. The digital camcorder of claim 1, wherein the Wi-Fi module also wirelessly receives video signals encoded in the instant messaging communication system's transmission format, and an instant messaging system conversion application changes the video signals in the instant messaging communication system's format to another format displayable on the display and audible from a speaker in the video camera.

4. The digital camcorder of claim 1, wherein the camera's application software may reserve portions of the internal memory for recording a video file, which can then be later retrieved and sent to another computing device.

5. The digital camcorder of claim 1, wherein the camera's application software may also reserve a portion of the internal/removable non-volatile memory to record a video or audio phone call conducted through the camera while the phone call is occurring and store the phone call data file for later recall.

6. The digital camcorder of claim 1, wherein the Wi-Fi module to encode audio and video data files is a wireless module that transmits according to an IEEE 802.11 standard and transmits packet in a VoIP format.

7. The digital camcorder of claim 1, wherein the compression logic further compresses the video data as it is placed into packets prior to wireless transmission by the Wi-Fi module so the further compressed video data can travel more quickly to the target computing device.

8. The digital camcorder of claim 1, wherein the Wi-Fi application of the Wi-Fi module has code to detect and connect to any router or Wi-Fi connection within the range of the video camera's broadcast area, when the user turns on the Wi-Fi feature of the digital camera.

9. The digital camcorder of claim 1, wherein the Wi-Fi module also has a transmitter that has multiple levels of power boost to extend the transmission range of the Wi-Fi signal from the antenna.

10. The digital camcorder of claim 1, wherein the digital view finder's display is rotatably attached to the camera body to allow the digital viewfinder's display to rotate, and the display is configured for two way viewing between caller and callee showing both what video images are being transmitted from the Wi-Fi module and what video images are being received by the Wi-Fi module.

11. The digital camcorder of claim 10, wherein the camera application software has code to allow the user to choose to see on the display all three of the following options, what video file the Wi-Fi module is broadcasting, the video file being received by the Wi-Fi module or both the received and transmitted video files concurrently on the same display.

12. The digital camcorder of claim 1, wherein the lens for capturing video is rotatably attached to the camera body and the display and the lens are on the same side of camera

13. The digital camcorder of claim 1, wherein two or more separate lenses for capturing video connect to the camera body, where a first lens connects physically in the front of the camera and another mounts in the back for focusing on the user viewing the display.

14. The digital camcorder of claim 1, further comprising a TV out module and jacks in the camera body to convert the video signals into a TV format and whatever video file or video files are being presented on the display will also be projected onto a connected TV set.

15. The digital camcorder of claim 1, wherein the camera's application software has code to allow received text messages from another communication device to be overlaid and displayed on the display even during a phone call in which the Wi-Fi module is receiving video data files being displayed on the display.

16. The digital camcorder of claim 1, wherein the camera's application software has code and the Wi-Fi module is configured when turned on to continuously feed recorded video files in the internal memory wirelessly to any detected and communications connected Wi-Fi router base station within the broadcast range and then the video files are routed to a server on the Internet for more permanent storage, and after all of a video file or a portion a video file broken up into discreet segments is confirmed successfully transferred to the server on the Internet, then the camera's application software has code to erase all or that segment of the video file from the video camera's internal memory.

17. A method, comprising:
supplying images to a digital video image sensor of a digital video player and recorder;
capturing audio frequencies corresponding to the captured images;
storing digital video footage including video images captured by the digital video image sensor and the captured sound data from the audio frequencies;
encoding digital video footage files into packets to be transmitted at frequencies and data rates established by a Wi-Fi standard, where the data in the transmitted packets is compressed;
transmitting and receiving the packets wirelessly as radio frequency waves at transmitted frequencies and data rates established by the Wi-Fi standard to and from a Wi-Fi enabled router base station and then to an instant messaging communication system that uses the Internet and then onto another target computing device capable of playing and displaying video files;
making phone calls over the Internet by breaking the digital video footage files into the packets, formatting the packets into compliance with a protocol of the instant messaging communication system, associating the target computing device's phone number or network address with the packets, and specially marking the packets that contain video data, wherein the packets are being captured, encoded, and then transmitted during the phone call;
allowing a user to see the images in a target area to be captured in the digital video footage and then stored in an internal memory of a digital video player and recorder;
compressing a size of the captured digital video footage; and
powering the digital video player and recorder with a DC power supply.

18. The method of claim 17, wherein two or more displays are part of the digital video camera and a first display attaches a front side of the camera body and a second display attaches a back side of the camera body and the user is given the option of at least what video file the Wi-Fi module is broadcasting, the video file being received by the Wi-Fi module, or both the received and transmitted video files concurrently on the same display.

19. The method of claim 18, further comprising:
wirelessly receiving video signals encoded in the instant messaging communication system's transmission format; and
converting changes in the video signals in the instant messaging communication system's format to another format displayable on at least one of the displays; and
reserving portions of the internal memory for recording a video or audio phone call conducted through the camera while the phone call is occurring and store the phone call data file for later recall.

20. The method of claim 19, further comprising:
detecting and connecting to any router or Wi-Fi connection within the range of the video camera's broadcast area, when the user turns on the Wi-Fi feature of the digital camera, wherein the Wi-Fi module to encode audio and video data files is a wireless module that transmits according to an IEEE 802.11 standard and transmits packet in a VoIP format
